(19) United States
(12) Patent Application Publication
(10) Pub. No.: US 2015/0302131 A1
(43) Pub. Date: Oct. 22, 2015

(54) INFORMATION PROCESSING APPARATUS AND BACK ANNOTATION METHOD

(71) Applicant: FUJITSU LIMITED, Kawasaki-shi (JP)

(72) Inventor: Kazuhiro Matsuzaki, Kawasaki (JP)

(73) Assignee: FUJITSU LIMITED, Kawasaki-shi (JP)

(21) Appl. No.: 14/632,156

(22) Filed: Feb. 26, 2015

(30) Foreign Application Priority Data
Apr. 22, 2014 (JP) 2014-088529

(51) Int. Cl. G06F 17/50

(52) U.S. Cl. CPC G06F 17/5072

(57) ABSTRACT

A back annotation method includes a first process, a second process, and a third process. In the first process, first information is determined. In the second process, second information to be reflected into the first information is determined. In the third process, whether the first information is being locked is determined based on a log file. When it is determined that the first information is being locked, it is requested that a back annotation process for reflecting the second information into the first information is performed in the first process. When it is determined that the first information is not being locked, the back annotation process is performed in the third process.

### CROSS-REFERENCE TO RELATED APPLICATION

This application is based upon and claims the benefit of priority from the prior Japanese Patent Application No. 2014-088529 filed on Apr. 22, 2014, the entire contents of which are incorporated herein by reference.

### FIELD

The embodiments discussed herein are related to an information processing apparatus and a back annotation method.

### BACKGROUND

A logic design (a circuit design) and a mounting design have been performed using a computer aided design (CAD) in a design field such as a printed circuit board design, a large scale integrated circuit (LSI)/field programmable gate array (FPGA) design, or a harness design. In the design process using the CAD, in some cases, a back annotation may be performed in which information determined by the subsequent mounting design process is reflected into the previous circuit design process.

For example, in the printed circuit board design, loading coordinates of a part on a substrate are marked on a circuit diagram in order to trace a defective portion in the circuit diagram during the debug and test of the designed printed circuit board. The loading coordinates are information determined during the mounting design, which is a process subsequent to the circuit design, and reflected by the back annotation.

Related techniques are disclosed in, for example, Japanese Laid-Open Patent Publication No. 9-198426, Japanese Laid-Open Patent Publication No. 2003-316841, and Japanese Laid-Open Patent Publication No. 2004-287831.

However, in the above-mentioned related art, data regarding a circuit diagram is locked when a user is designing the circuit using a CAD, so that the back annotation regarding information determined during the mounting design may not be performed in some cases. Therefore, in some cases, it takes time to reflect the information determined during the mounting design into the circuit design side.

### SUMMARY

According to an aspect of the present invention, provided is a back annotation method including a first process, a second process, and a third process. In the first process, first information is determined. In the second process, second information to be reflected into the first information is determined. In the third process, whether the first information is being locked is determined based on a log file. When it is determined that the first information is being locked, it is requested that a back annotation process for reflecting the second information into the first information is performed in the first process. When it is determined that the first information is not being locked, the back annotation process is performed in the third process.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary system configuration according to a first embodiment;

FIG. 2 is a diagram illustrating a design process;

FIG. 3 is a diagram illustrating an exemplary functional configuration;

FIG. 4 is a diagram illustrating back annotation;

FIG. 5 is a diagram illustrating an example of a log file;

FIG. 6 is a flowchart illustrating an exemplary back annotation process;

FIG. 7 is a diagram illustrating an example of BA information;

FIG. 8 is a diagram illustrating an example of BA information;

FIG. 9 is a flowchart illustrating an exemplary process of a circuit design CAD;

FIG. 10 is a flowchart illustrating an exemplary back annotation process according to a second embodiment;

FIG. 11 is a flowchart illustrating an exemplary back annotation process according to a third embodiment;

FIG. 12 is a flowchart illustrating an exemplary process of a circuit design CAD according to the third embodiment; and

FIG. 13 is a diagram illustrating an exemplary configuration of a computer.

### DESCRIPTION OF EMBODIMENTS

Hereinafter, an information processing apparatus and a back annotation method according to embodiments will be described with reference to the drawings. In the embodiments, components having a similar function are denoted by similar reference numerals and redundant descriptions thereof will be omitted. The information processing apparatus and the back annotation method which will be described in the following embodiments are illustrative only, and embodiments are not limited thereto. Further, the following embodiments may be appropriately combined within a non-contradictory range.

### First Embodiment

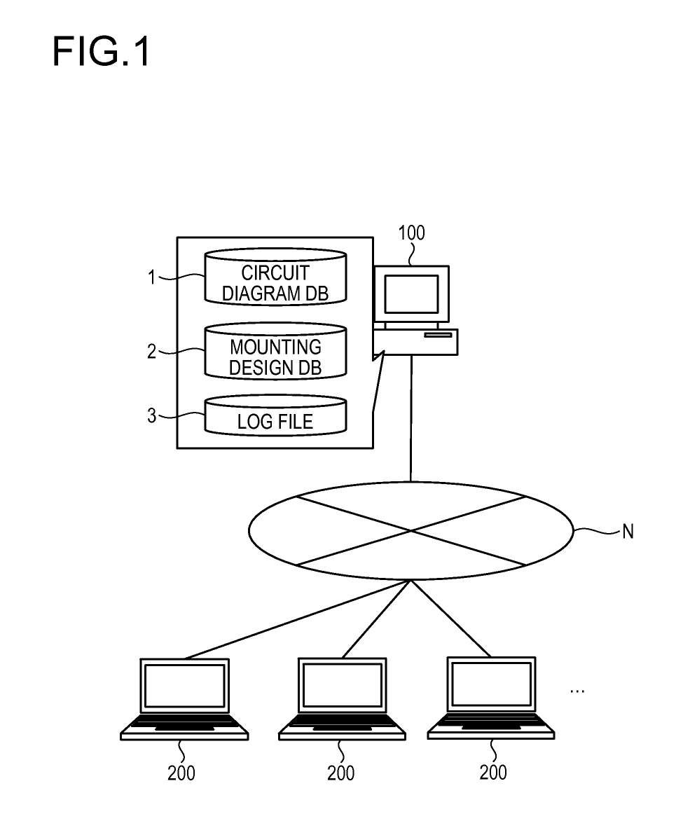

FIG. 1 is a diagram illustrating an exemplary system configuration according to a first embodiment. As illustrated in FIG. 1, a system according to the first embodiment performs a circuit design and a mounting design using a CAD and includes a server device 100 and computers 200. The server device 100 and the computers 200 are connected to communicate with each other through a communication network N such as a local area network (LAN). In the first embodiment, a system which performs the circuit design and the mounting design for a printed circuit board design is described but the system may be a system for LSI/FPGA design or a harness design.

The server device 100 is a file server or the like which provides information in a circuit diagram database (DB) 1, a mounting design DB 2, and a log file 3 to the computers 200. The computers 200 are, for example, personal computers (PCs) and are terminals through which a user uses a CAD for the circuit design or a CAD for the mounting design to perform the circuit design or the mounting design.

The circuit diagram DB 1 is a database in which information determined during the circuit design is stored. The information includes, for example, a circuit diagram indicating an electrical or logical configuration of a circuit to be designed. Specifically, the circuit diagram DB 1 stores therein information on parts (an integrated circuit (IC), a transistor, and the like) which configure the circuit and a connection configuration of these parts, for every item, for each circuit to be designed.

The mounting design DB 2 is a database in which information determined during the mounting design is stored. The information includes, for example, a mounting configuration including a layout of parts in a circuit to be designed and part numbers. Specifically, the mounting design DB 2 stores therein information such as a loading position on a substrate, a wiring position, or a model number of a part which configures the circuit, for every item, for each circuit to be designed. In the circuit diagram DB 1 and the mounting design DB 2, the same identification information (an identifier (ID) or a work name) is allocated to the same circuit. Therefore, it is possible to obtain manufacturing data for actually manufacturing a circuit to be designed through the circuit design and the mounting design by extracting data with the same identification information from the circuit diagram DB 1 and the mounting design DB 2.

The log file 3 is a file in which information on an operation of a currently activated CAD is sequentially described. Specifically, information on a CAD which is currently activated and edited contents of the currently activated CAD are described in a time series manner in the log file 3. Further, information on a part (an IC, a transistor, or the like) which is exclusively edited by the activated CAD, by locking as an editing target so as not to be edited by another CAD, is described in a time series manner in the log file 3.

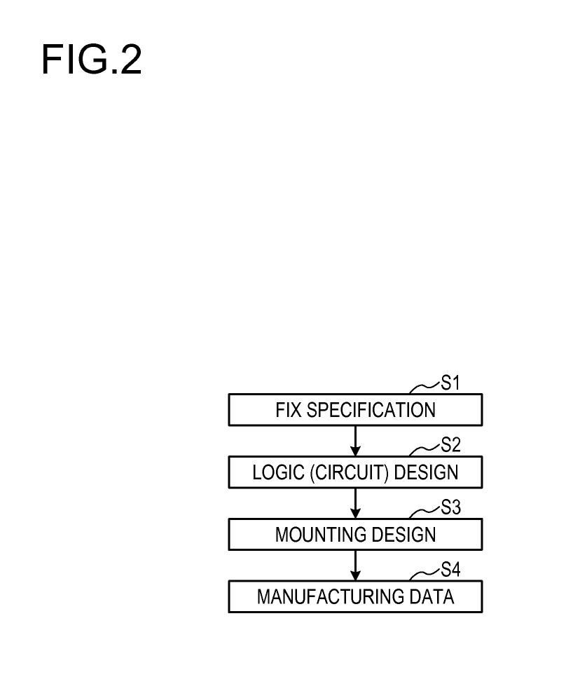

FIG. 2 is a diagram illustrating a design process. More specifically, FIG. 2 is a diagram illustrating a design process for performing a printed circuit board design using the system illustrated in FIG. 1.

As illustrated in FIG. 2, in the printed circuit board design, first, a specification required for a printed circuit board to be designed is fixed (S1). Next, a logic (circuit) design for creating a circuit diagram employing individual parts such as an IC and a transistor is performed using an editor (hereinafter, a circuit design CAD) such as a CAD for the circuit design so as to satisfy the required specification (S2). Next, a mounting design for determining a loading position on a substrate, a wiring position, and a model number of each part in the circuit diagram created during the circuit design is performed using an editor (hereinafter, a mounting design CAD) such as a CAD for the mounting design (S3). Next, manufacturing data for a printed circuit board to be designed, which is determined through the circuit design and the mounting design, is obtained from the circuit diagram DB 1 and the mounting design DB 2 (S4).

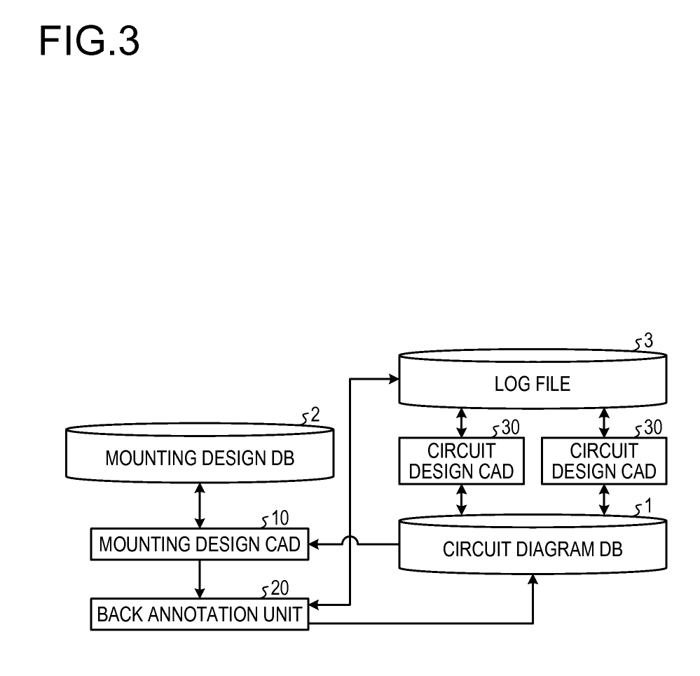

FIG. 3 is a diagram illustrating an exemplary functional configuration. Specifically, FIG. 3 is a diagram illustrating a functional configuration for a circuit design and a mounting design in the system illustrated in FIG. 1.

As illustrated in FIG. 3, the functional configuration for a circuit design and a mounting design includes a mounting design CAD 10, a back annotation unit 20, and circuit design CADs 30. The mounting design CAD 10 is implemented by executing a program by the computer 200 and edits and determines the loading position on the substrate, the wiring position, and the model number of each part in the circuit diagram in accordance with manipulation of the user.

Specifically, the mounting design CAD 10 reads data of a circuit to be edited from the circuit diagram DB 1 and displays the data on a monitor as a circuit diagram. Next, the mounting design CAD 10 receives a manipulation (selection or instruction with a mouse) from a user through a graphical user interface (GUI) for each part in the circuit diagram to perform editing and determination regarding the mounting design. Further, the mounting design CAD 10 sets information determined for the mounting design in accordance with the instruction of the user in the mounting design DB 2. Further, when there is back annotation information (hereinafter, BA information) which needs to be reflected into the circuit diagram DB 1 among information determined for the mounting design, the mounting design CAD 10 calls the back annotation unit 20 to request back annotation which reflects the BA information into the circuit diagram DB 1.

The back annotation unit 20 is implemented by executing a program by the computer 200 and, for example, is an application programming interface (API) or the like which is called by the mounting design CAD 10. The back annotation unit 20 performs a back annotation process (described later in detail) for reflecting the BA information requested from the mounting design CAD 10 into the circuit diagram DB 1.

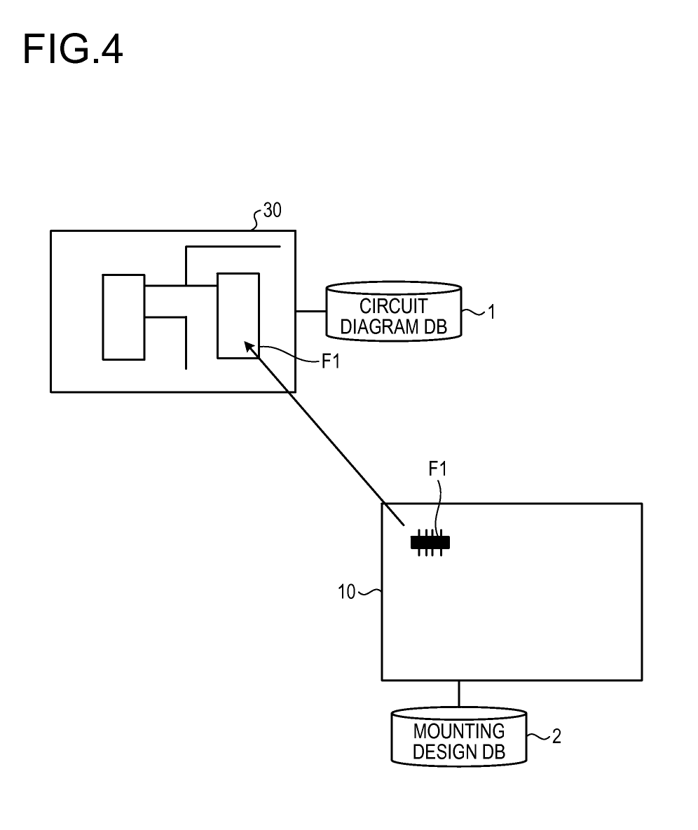

FIG. 4 is a diagram illustrating the back annotation. As illustrated in FIG. 4, among information determined by the mounting design CAD 10 for a part F1 such as an IC in the circuit diagram, information on the loading coordinates of the part F1 are referred to as BA information which needs to be reflected into the circuit diagram DB 1. When the loading coordinates of the part F1, among the items in the mounting design DB 2, are determined, the mounting design CAD 10 considers the loading coordinates of the part F1 as BA information and requests the back annotation for the circuit diagram DB 1 to the back annotation unit 20. Items in the mounting design DB 2, which are considered as the BA information, are set in advance as setting information and may include not only the loading coordinates of the part F1 but also a part number of the part F1.

The circuit design CAD 30 is implemented by executing a program by the computer 200, and performs editing and determination regarding a circuit diagram which illustrates an electrical or logical configuration for a circuit to be designed in accordance with the manipulation of the user.

Specifically, the circuit design CAD 30 receives a manipulation (selection or instruction with a mouse) from the user through the GUI to perform editing and determination regarding the circuit design. Further, the circuit design CAD 30 sets information determined for the circuit design in accordance with the instruction of the user in the circuit diagram DB 1. Further, the circuit design CAD 30 writes the log file 3 at the time of activating the circuit design CAD 30 or editing the circuit diagram DB 1, and also shares information among a plurality of activated circuit design CADs 30 by sequentially referring to the log file 3. Specifically, the circuit design CAD 30 records in the log file 3 an ID identifying its own task at the time of activating or completing the circuit design CAD 30 together with information indicating activation or completion. Further, the circuit design CAD 30 records, in the log file 3, information on a part F1 which is exclusively edited by locking as an editing target so as not to be edited by another CAD, edited contents for the circuit diagram DB 1, and the like.

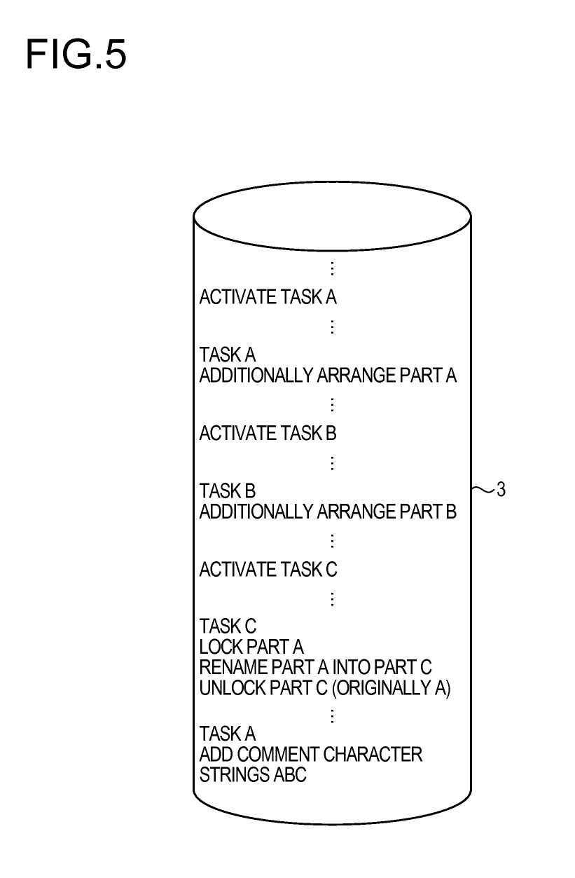

FIG. 5 is a diagram illustrating an example of the log file 3. As illustrated in FIG. 5, task information for each of the plurality of activated circuit design CADs 30 is sequentially recorded in the log file 3 in a time series manner. The circuit design CADs 30 share the edited state by each task by sequentially referring to the log file 3. For example, in an example illustrated in FIG. 5, activation of “task A”, “task B”, and “task C” is recorded but completion for the tasks is not recorded, so that may be understood that “task A”, “task B”, and “task C” are currently activated. Further, additional arrangement of “part A” by “task A” and additional arrangement of “part B” by “task B” are recorded, so that information on additionally arranged “part A” and “part B” may be shared among “task A”, “task B”, and “task C”.

In the log file 3, it is recorded that “part A” is locked and released by “task C”. Therefore, after recording that “part A” is locked by “task C”, a fact that “part A” is being locked by “task C” may be shared among “task A”, “task B”, and “task C” until it is recorded that the locking of “part A” is released.

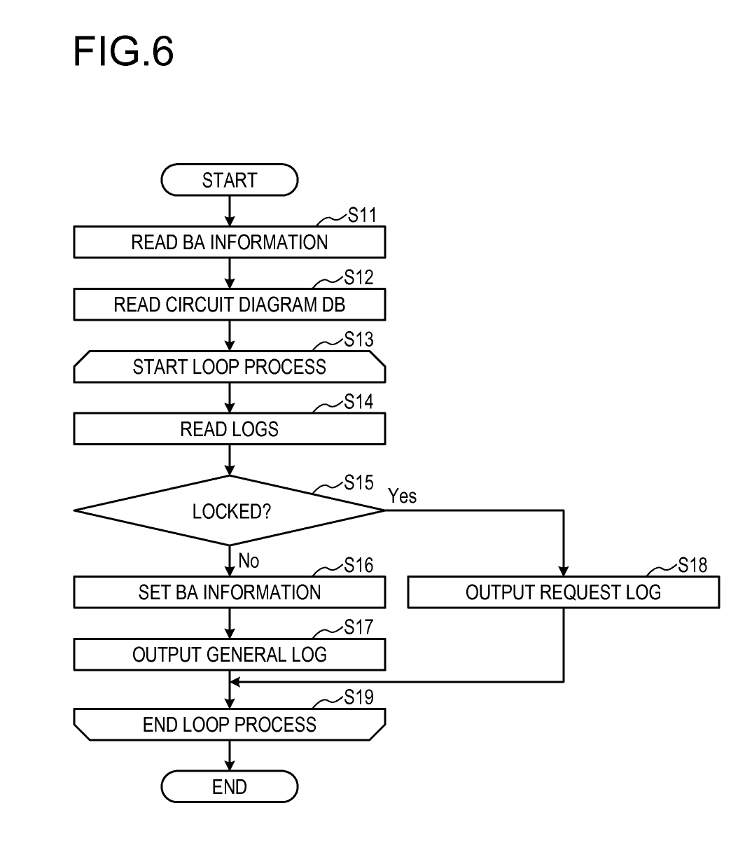

Next, details of a back annotation process performed by the back annotation unit 20 will be described. FIG. 6 is a flowchart illustrating an exemplary back annotation process.

As illustrated in FIG. 6, when the back annotation unit 20 is called by the mounting design CAD 10 to start the process, the back annotation unit 20 reads the BA information I1 requested from the mounting design CAD 10 (S11) and reads the circuit diagram DB 1 (S12).

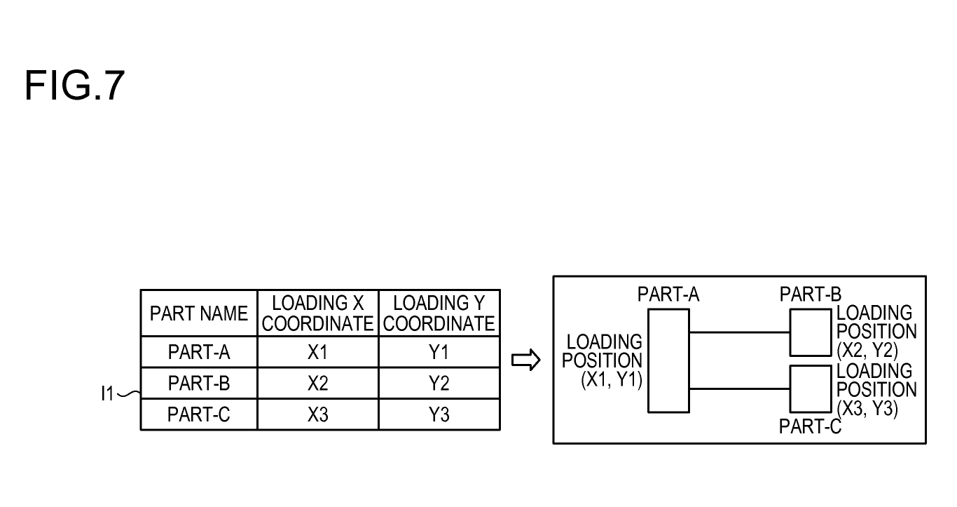

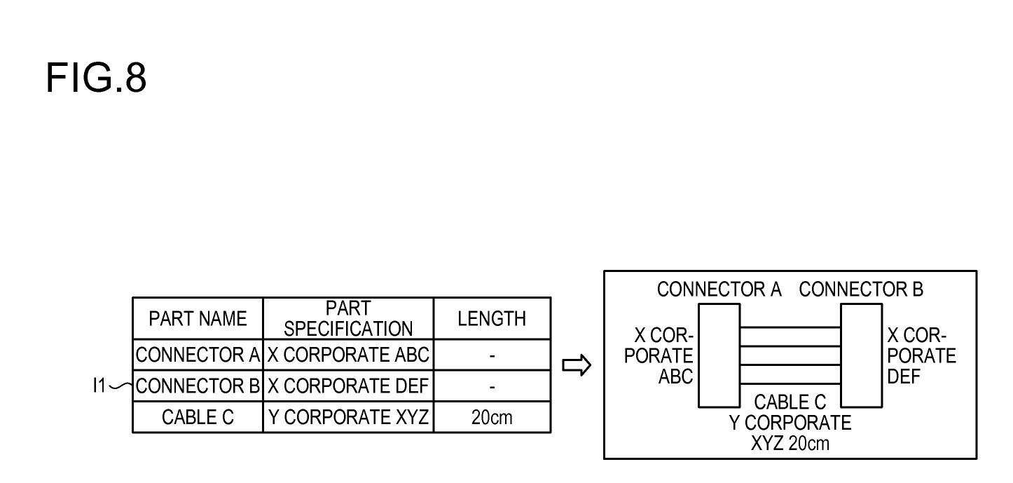

FIGS. 7 and 8 are diagrams each illustrating an example of BA information I1. More specifically, the BA information I1 illustrated in FIG. 7 is loading coordinates of the part F1, and the BA information I1 illustrated in FIG. 8 is a part specification and a length of the part F1. As illustrated in FIGS. 7 and 8, the BA information I1, which is represented on the circuit diagram in order to trace a defective portion in a circuit diagram during the debug and test, includes the loading coordinates (loading position), the part specification, and the length of the part F1, and the like. When the back annotation unit 20 is called by the mounting design CAD 10 to start the process, the back annotation unit 20 reads the BA information I1.

Next, the back annotation unit 20 starts a loop process (S13 to S19) for each part F1 included in the BA information I1. Specifically, in the example of FIG. 7, the loop process is performed for each of “PART-A”, “PART-B”, and “PART-C”. Further, in the example of FIG. 8, the loop process is performed for each of “connector A”, “connector B”, and “cable C”.

When the loop process starts (S13), the back annotation unit 20 reads the logs of the circuit design CADs 30 until the present time by referring to the log file 3 (S14). Next, the back annotation unit 20 determines whether the part F1 to be processed is locked by any of the activated circuit design CADs 30, based on the read logs (S15). For example, in the log file 3 illustrated in FIG. 5, it is determined whether the part F1 to be processed is locked by any one of “task A”, “task B”, and “task C”.

When it is determined that the part is not locked (NO at S15), the back annotation unit 20 sets the BA information I1 in the circuit diagram DB 1 by itself (S16). Specifically, the back annotation unit 20 sets, in the circuit diagram DB 1, the contents of the BA information I1 in an item of a circuit having the same identification information as a circuit to which the BA information I1 is to be reflected.

Therefore, when the part F1 to be processed is not locked, the back annotation unit 20 may promptly reflect the BA information I1 into the circuit diagram DB 1. Further, since the loop process is performed for each part F1, the BA information I1 may be reflected into the circuit diagram DB 1 regardless of whether other parts are locked.

Next, the back annotation unit 20 outputs, to the log file 3, a general log indicating that the BA information I1 is set in the circuit diagram DB 1 (S17). Specifically, the back annotation unit 20 describes in the log file 3 a fact indicating that the BA information I1 for the part F1 is set. Accordingly, the activated circuit design CADs 30 may share the fact indicating that the BA information I1 is set to the circuit diagram DB 1 by the back annotation unit 20.

When it is determined that the part is locked (YES at S15), the back annotation unit 20 outputs, to the log file 3, a request log requesting the circuit design CAD 30, which is locking the part, to perform back annotation of the BA information I1 (S18). Specifically, the back annotation unit 20 describes, in the log file 3, a log having contents requesting the locking circuit design CAD 30 to reflect the BA information I1 into the circuit diagram DB 1. Accordingly, the circuit design CAD 30 as the request destination may reflect the BA information I1 regarding the part F1, which is locked by the circuit design CAD 30, into the circuit diagram DB 1.

The back annotation unit 20 ends the loop process at a time when the above-described S14 to S18 are performed on all parts F1 included in the BA information I1 (S19). Therefore, the back annotation is performed on all parts F1 included in the BA information I1.

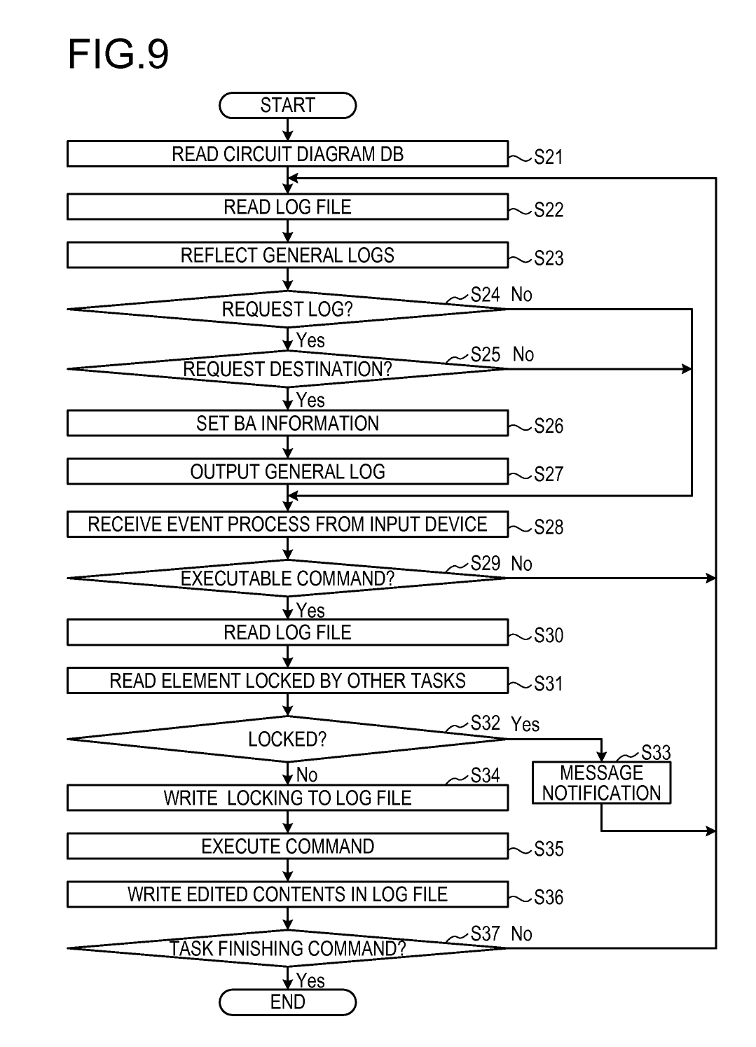

Next, details of the process of the circuit design CAD 30 will be described. FIG. 9 is a flowchart illustrating an exemplary process of the circuit design CAD 30. As illustrated in FIG. 9, when the process starts by an instruction of activating the circuit design CAD 30, the circuit design CAD 30 reads the circuit diagram DB 1 and the log file 3 (S21 and S22).

Next, the circuit design CAD 30 develops general logs described in the log file 3, such as a state (whether to be activated, edited contents, and the like) of other circuit design CADs 30, the contents of the back annotation performed by the back annotation unit 20, and the like, in the memory to reflect the general logs into latest information (S23). Accordingly, a representation in the circuit diagram of the circuit design CAD 30 is updated with the latest contents described in the log file 3.

Next, the circuit design CAD 30 determines whether there is a request log requesting back annotation of BA information I1 among the logs described in the log file 3 (S24). When it is determined that there is no request log (NO at S24), the circuit design CAD 30 progresses the process to S28.

When it is determined that there is a request log (YES at S24), the circuit design CAD 30 determines whether the circuit design CAD 30 itself is the request destination of the request log (S25). For example, when an ID indicating the circuit design CAD 30 itself in the log file 3 is “task A”, it is determined whether the request destination of the request log is “task A”. When it is determined that the circuit design CAD 30 itself is not the request destination (NO at S25), the circuit design CAD 30 does nothing for the requested content described in the request log and progresses the process to S28.

When it is determined that the circuit design CAD 30 itself is the request destination (YES at S25), the circuit design CAD 30 sets the BA information I1 to the circuit diagram DB 1 in accordance with the request log (S26) and outputs, to the log file 3, a general log indicating that the BA information I1 is set to the circuit diagram DB 1 (S27). Accordingly, the circuit design CAD 30 as the request destination reflects the BA information I1 regarding the part F1, which is locked by the circuit design CAD 30, into the circuit diagram DB 1.

The circuit design CAD 30 receives an event process from an input device such as a mouse or a keyboard (S28) and determines whether a command received in the event process is an executable command (S29).

Specifically, at S29, it is determined whether a command other than a command which is executable in the circuit design is received in the event process. For example, a command for selection, move, or the like, of the part F1 is determined as a command which is executable in the circuit design. Change of a part number of the part F1 or the like is a command which is executable in the mounting design but not in the circuit design, so that the change of a part number is determined as a command which is not executable in the circuit design. When it is determined that the command is not an executable command (NO at S29), the circuit design CAD 30 returns the process to S22 and reads the log file 3.

When it is determined that the command is an executable command (YES at S29), the circuit design CAD 30 reads the log file 3 (S30) to read elements locked by other tasks. That is, the circuit design CAD 30 reads information of parts F1 locked by other circuit design CADs 30 (S31).

Next, the circuit design CAD 30 determines whether a part F1 serving as a processing target element of the command is locked by another circuit design CAD 30 (S32). When it is determined that the part F1 is locked (YES at S32), the circuit design CAD 30 makes a message notification indicating that the part F1 is locked by another circuit design CAD 30 and the command is not executable (command cancel) on a monitor or the like (S33).

When it is determined that the part F1 is not locked (NO at S32), the circuit design CAD 30 writes in the log file 3 that the part F1 serving as a processing target element of the command is a locked element(S34). Specifically, the circuit design CAD 30 describes in the log file 3 that the part F1 serving as a processing target of the command is locked. Accordingly, the circuit design CAD 30 may notify other circuit designs CAD 30 and the back annotation unit 20 that the part F1 serving as a processing target of the command is locked.

Next, the circuit design CAD 30 executes the received command (S35) and writes, in the log file 3, edited contents newly reflected by executing the command (S36). Accordingly, the edited contents newly reflected may be shared by other circuit design CADs 30.

Next, the circuit design CAD 30 determines whether a task finishing command to finish its own task is input (S37). When it is determined that the task finishing command is not input (NO at S37), the circuit design CAD 30 returns the process to S22. When it is determined that the task finishing command is input (YES at S37), the circuit design CAD 30 ends the process.

### Second Embodiment

Next, a second embodiment will be described. In the second embodiment, in contrast to the above-described first embodiment, even though a part F1 to be processed is not locked, the back annotation unit 20 itself does not reflect the BA information I1 but requests an arbitrary task to reflect the BA information I1.

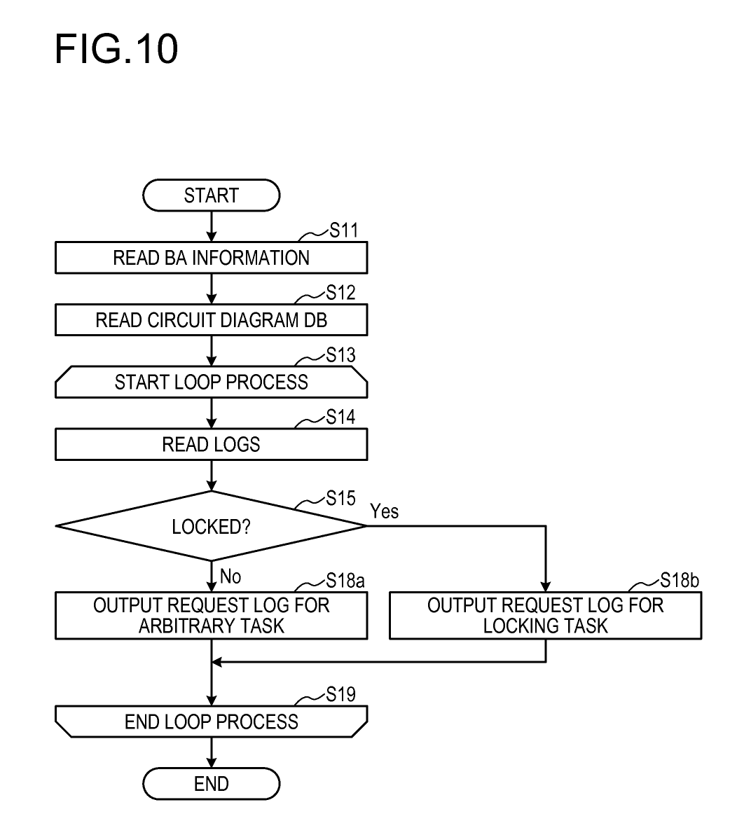

FIG. 10 is a flowchart illustrating an exemplary back annotation process according to the second embodiment. As illustrated in FIG. 10, when it is determined that the part F1 to be processed is not locked (NO at S15), the back annotation unit 20 outputs, to the log file 3, a request log requesting an arbitrary circuit design CAD 30 (task) the back annotation of the BA information I1 (S18a). The arbitrary task may be any activated task and for example, any activated task may be designated in a random manner or a round-robin manner. Accordingly, the arbitrary circuit design CAD 30 as the request destination may reflect the BA information I1 regarding the part F1 into the circuit diagram DB 1.

When it is determined that the part F1 is locked (YES at S15), the back annotation unit 20 outputs, to the log file 3, a request log requesting the locking circuit design CAD 30 (task) the back annotation of the BA information I1 (S18b).

### Third Embodiment

Next, a third embodiment will be described. In the third embodiment, in contrast to the above-described embodiments, the back annotation unit 20 itself does not reflect the BA information I1 but requests all tasks to reflect the BA information I1.

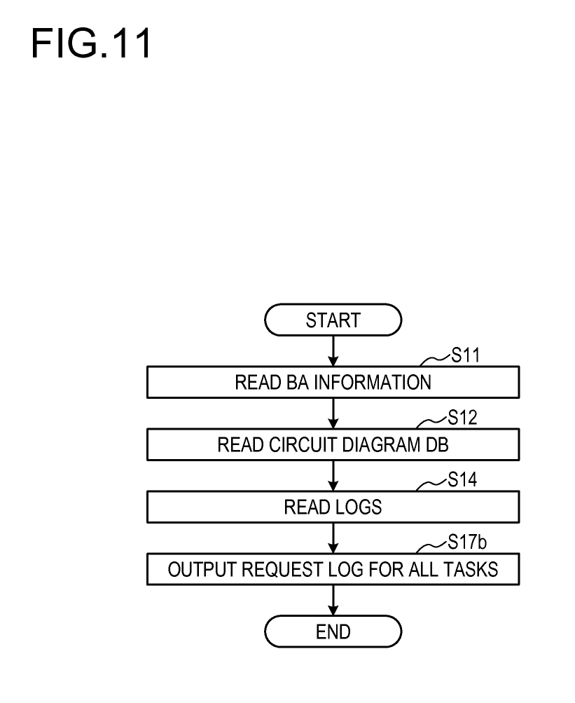

FIG. 11 is a flowchart illustrating an exemplary back annotation process according to the third embodiment. As illustrated in FIG. 11, when the back annotation unit 20 is called by the mounting design CAD 10 to start the process, the back annotation unit 20 reads the BA information I1 requested from the mounting design CAD 10 (S11) and reads the circuit diagram DB 1 (S12).

Next, the back annotation unit 20 reads the logs of the circuit design CAD 30 until the present time by referring to the log file 3 (S14) and outputs, to the log file 3, a request log requesting all currently activated tasks the back annotation of the BA information I1 (S17b). Accordingly, the back annotation unit 20 itself does not reflect the BA information I1 and requests all tasks to reflect the BA information I1.

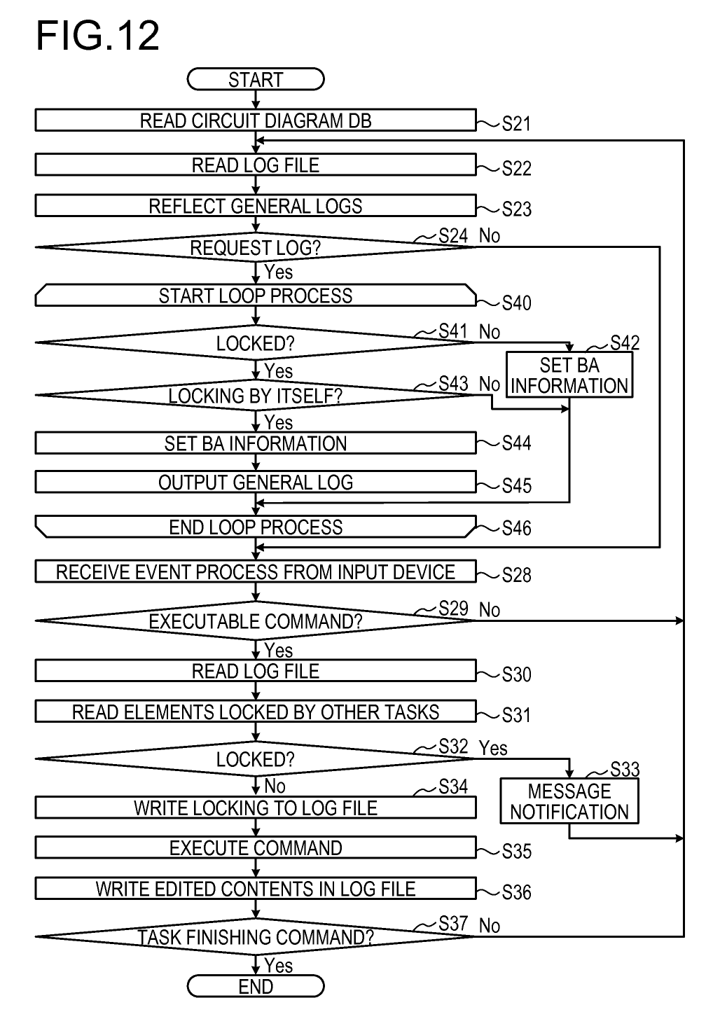

FIG. 12 is a flowchart illustrating an exemplary process of the circuit design CAD 30 according to the third embodiment. As illustrated in FIG. 12, in the third embodiment, when it is determined that there is a request log at S24 (YES at S24), the contents of a subsequent process are different from those of the above-described embodiments.

Specifically, when it is determined that there is a request log (YES at S24), the circuit design CAD 30 starts a loop process (S40 to S46) for each part F1 included in the BA information I1 of the request log.

Next, when the loop process starts (S40), the circuit design CAD 30 determines whether a part F1 serving as a processing target element is locked by any activated circuit design CAD 30 (S41). When it is determined that the part F1 is not locked (NO at S41), the circuit design CAD 30 itself sets the BA information I1 in the circuit diagram DB 1 (S42).

When it is determined that the part F1 is locked (YES at S41), the circuit design CAD 30 determines whether the circuit design CAD 30 itself is locking the part F1 (S43). When it is determined that the circuit design CAD 30 itself is not locking the part F1 (NO at S43), since another circuit design CAD 30 (task) is locking the part F1, the circuit design CAD 30 does nothing and progresses the process to S46.

When it is determined that the circuit design CAD 30 itself is locking the part F1 (YES at S43), the circuit design CAD 30 itself sets the BA information I1 to the circuit diagram DB 1 (S44) and outputs a general log to the log file 3 (S45).

The circuit design CAD 30 ends the loop process at a time when the above-described S40 to S45 are performed on all parts F1 included in the BA information I1 (S46). Therefore, the back annotation is performed on all parts F1 included in the BA information I1 which is requested for all tasks.

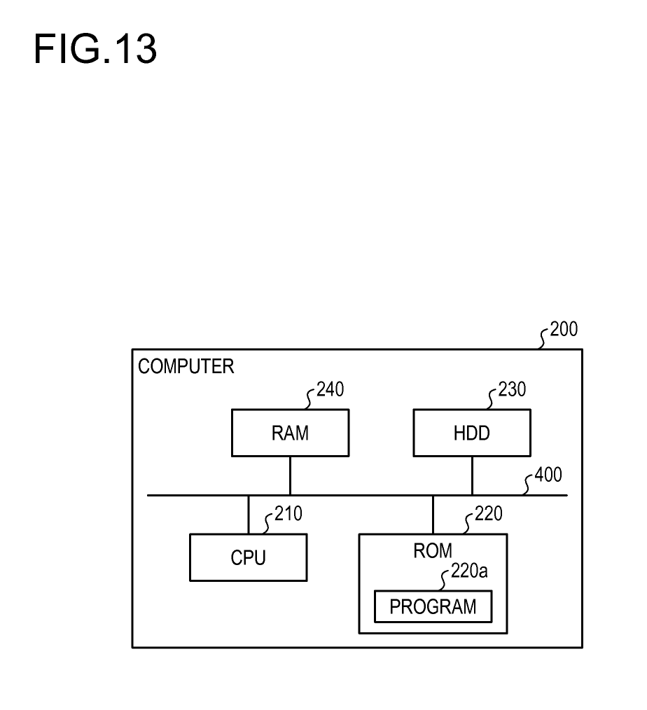

Various processes described in the above-described embodiments may be implemented by executing a prepared program by a computer 200 such as a personal computer or a work station. Therefore, a configuration of the computer 200 which executes a program that implements the same function as the above embodiments will be described below. FIG. 13 is a diagram illustrating an exemplary configuration of a computer.

As illustrated in FIG. 13, the computer 200 includes, for example, a central processing unit (CPU) 210, a read-only memory (ROM) 220, a hard disk driver (HDD) 230, and a random access memory (RAM) 240. These components 210 to 240 are connected one another by a bus 400.

In the ROM 220, a program 220a for implementing the same function as the mounting design CAD 10, the back annotation unit 20, and the circuit design CAD 30 is stored in advance. The program 220a may be appropriately divided for each of the mounting design CAD 10, the back annotation unit 20, and the circuit design CAD 30.

The CPU 210 reads out the program 220a from the ROM 220 to execute the program 220a, thereby performing the same operation as the mounting design CAD 10, the back annotation unit 20, and the circuit design CAD 30.

The program 220a does not need to be stored in advance in the ROM 220. For example, the program may be stored in advance in a portable physical medium, which is to be inserted into the computer 200, such as a flexible disk (FD), a compact disc ROM (CD-ROM), a digital versatile disc (DVD), an optical magnetic disk, an IC card. The computer 200 may read out the program from the portable physical medium to execute the program.

The program may be stored in advance in another computer (or a server) connected to the computer 200 through a public line, the Internet, a LAN, or a wide area network (WAN). The computer 200 may read out the program from the other computer to execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable recording medium having stored therein a program for causing a computer to execute a process, the process comprising:
a first process of determining first information;
a second process of determining second information to be reflected into the first information; and
a third process including:
determining, based on a log file, whether the first information is being locked,
requesting, when it is determined that the first information is being locked, to perform in the first process a back annotation process for reflecting the second information into the first information, and
performing the back annotation process when it is determined that the first information is not being locked.

2. The computer-readable recording medium according to claim 1, wherein
the requesting is performed by outputting the second information to the log file.

3. The computer-readable recording medium according to claim 1, wherein
the second information is output to the log file in the third process when the back annotation process is performed in the third process.

4. An information processing apparatus, comprising:
a processor configured to
execute a first process of determining first information,
execute a second process of determining second information to be reflected into the first information, and
execute a third process including:
determining, based on a log file, whether the first information is being locked,
requesting, when it is determined that the first information is being locked, to perform in the first process a back annotation process for reflecting the second information into the first information, and
performing the back annotation process when it is determined that the first information is not being locked.

5. A back annotation method, comprising:
a first process of determining first information by a computer;
a second process of determining second information to be reflected into the first information; and
a third process including:
determining, based on a log file, whether the first information is being locked,
requesting, when it is determined that the first information is being locked, to perform in the first process a back annotation process for reflecting the second information into the first information, and
performing the back annotation process when it is determined that the first information is not being locked.
